(19) United States
(12) Patent Application Publication
(10) Pub. No.: US 2026/0069002 A1
(43) Pub. Date: Mar. 12, 2026

(54) ATTACHMENT MEMBER FOR CONNECTING A WRIST STRAP TO A WATCH CASE

(71) Applicant: Manufacture d'Horlogerie Audemars Piguet SA, Le Brassus (CH)

(72) Inventor: Outman MAJID, Nyon (CH)

(73) Assignee: Manufacture d'Horlogerie Audemars Piguet SA, Le Brassus (CH)

(21) Appl. No.: 19/107,714

(22) PCT Filed: Sep. 1, 2023
(86) PCT No.: PCT/IB2023/058648

§ 371 Date: Feb. 28, 2025

(30) Foreign Application Priority Data
Sep. 5, 2022 (EP) 22193832.7

(51) Int. Cl. A44C 5/14; G04B 37/00

(52) U.S. Cl. CPC A44C 5/147; G04B 37/0008

(57) ABSTRACT

An attachment member intended for being secured between a pair of horns of a watch case, comprising two pairs of horns, for connecting the watch case to an attachment end of a wrist strap. The attachment member comprises a coupling element configured to engage with the attachment end in order to couple the coupling element and the attachment end by interlocking in a direction perpendicular or oblique to a plane defined by the two pairs of horns of the watch case. The attachment member further comprises a latch for locking and unlocking the coupling of the coupling element to the attachment end. The present invention also relates a wrist strap comprising an attachment end configured to be connected, by interlocking, to the attachment member.

### TECHNICAL FIELD

The present invention concerns an attachment member intended to be fixed between a pair of horns of a watch case for the connection of a wrist strap to the watch case. The invention also concerns a wrist strap comprising an attachment end configured to be connected to the attachment member and a wristwatch comprising two attachment members fixed to two pairs of horns on either side of the watch case and two wrist straps of a bracelet connected to the attachment members.

### STATE OF THE ART

Numerous mechanisms have already been proposed to simplify the assembly/disassembly of a bracelet to a watch case in order to avoid the use of a specific tool. This allows the wearer of the watch for example to change the style or colour of the bracelet at will, without complicated handling and without the risk of damaging or scratching the watch case through the clumsy use of a tool.

These mechanisms often have the disadvantage of requiring modifications to be made to the watch case so that it can be adapted to cooperate with the attachment end of each of the wrist straps of the bracelet. Other mechanisms incorporate pushers in the attachment end to enable the wrist strap to be fastened to the watch case, as well as detached from it. Replacing or adapting a bracelet to different watch cases in a collection necessarily involves significant costs.

By way of example, CH564922 discloses a mechanism comprising a female element connected to the horns of the watch case and comprising a casing housing a latch and comprising an open side for receiving therein a male element of a wrist strap. The male element has two projections intended to fit into two circular holes in a wall of the casing. The latch comprises guiding means so that the projections are aligned with the circular holes when the male element is inserted into the casing.

This mechanism has several disadvantages. The circular holes are not directly visible to the user, which makes the mechanism more complex by incorporating the aforementioned guiding means. Furthermore, this mechanism does not allow the user to ensure that the fitting has been carried out correctly after inserting the male element into the opening of the casing of the female element. Lastly, locking the male element to the female element requires handling in two steps, since the user must first insert the male element in a direction along the plane defined by the general plane of the watch case and then lower the male element in a direction perpendicular to the general plane of the watch case in order to fit the projections into the holes in the female element.

Other examples of such mechanisms are disclosed in particular in publications CH712656B1, EP2353428B1, EP3213654A1 and CH698584B1.

An aim of the present invention is to solve, at least in part, the aforementioned disadvantages. This aim is achieved in particular by proposing an interchangeable attachment member intended to be fixed to a watch case and allowing a removable connection of a bracelet to this attachment member. The interchangeable nature of the attachment member has the advantage that it can be fitted to several watch cases without having to modify them. This makes it possible to modernise or renovate existing watches by replacing old bracelets with new or more recent bracelets.

Another aim of the present invention is not to make the watch case more complex in terms of the means it requires for achieving the connection with a bracelet.

Another aim of the present invention is to propose an attachment member that allows easy handling for connecting the wrist strap to the attachment member.

An additional aim of the present invention is to propose a wrist strap with a simplified attachment part to enable the bracelet to be replaced at lower cost.

### BRIEF SUMMARY OF THE INVENTION

These aims are achieved in particular by an attachment member intended to be fixed between a pair of horns of a watch case, comprising two pairs of horns, in order to connect the watch case to an attachment end of a wrist strap. For this purpose, the attachment member comprises a coupling element configured to engage with the attachment end in order to assemble the coupling element and the attachment end by interlocking in a direction perpendicular or oblique to a plane defined by the two pairs of horns of the watch case. The attachment member further comprises a latch movably mounted in a recess in the attachment member between a locked position and an unlocked position enabling the assembly of the coupling element and the attachment end to be locked and unlocked. The coupling element is configured to be located on a visible side of the attachment member when the assembly of the coupling element and the attachment end is not carried out and in that said assembly is carried out directly by interlocking the coupling element and the attachment end.

In an embodiment, the visible side of the attachment member is visible on the bezel side of the watch case when the attachment member is fixed between the pair of horns thereof and the attachment end is not connected to the attachment member.

In an embodiment, the latch comprises a hook or bolt configured to prevent separation between the attachment end and the coupling element when the latch is in the locked position.

In an embodiment, the movement of the latch is limited by a stop preventing the latch from moving out of the recess.

In an embodiment, the locked position of the latch is reached and maintained by the action of an elastic member on the latch.

In an embodiment, the latch comprises a gripping part enabling it to be moved in at least one direction between the locked and unlocked positions.

In an embodiment, the gripping part is arranged to be accessible from an invisible side of the attachment member when the latter is fixed between the pair of horns and when the watch case is viewed from the bezel side.

In an embodiment, the coupling element is formed by at least one female element configured to receive at least one male element of complementary shape of the attachment end.

In an embodiment, the coupling element is formed by at least two elements, from among female and/or male elements, arranged on either side of the recess of the latch.

In an embodiment, the attachment member further comprises a bearing surface intended to come into contact with the watch case. The bearing surface is configured to substantially prevent any rotation of the attachment member when it is fixed between the horns of the watch case.

In an embodiment, the bearing surface of the attachment member is of complementary shape to a portion of the watch case.

Another aspect of the invention relates to a wrist strap comprising an attachment end configured to be connected, by interlocking, to the attachment member of any of these embodiments.

In an embodiment, the attachment end comprises at least one male element configured to be fitted into the coupling element of the attachment member.

In an embodiment, the attachment end comprises a rim or a fixing window configured to cooperate with the latch of the attachment member in order to lock the assembly of the attachment end and the coupling element.

In an embodiment, the rim or the fixing window is located between at least two elements complementary to the male and/or female elements which form the coupling element of the attachment member.

In an embodiment, the attachment end is concealed beneath a portion of the wrist strap overlying the attachment member when the attachment end is assembled to the attachment member.

Another aspect of the invention relates to a wristwatch comprising a watch case comprising two pairs of horns, an attachment member, according to any of these embodiments, mounted between the horns of each pair of horns and a bracelet comprising a wrist strap, according to any of these embodiments, fixed to each attachment member.

### BRIEF DESCRIPTION OF THE FIGURES

Examples of embodiments of the invention are provided in the description illustrated by the appended figures in which:

FIG. 1 illustrates a top perspective view of a part of the watch case comprising the attachment member and an attachment end of a wrist strap, before connection of the attachment end, according to an embodiment,

FIG. 2 illustrates a perspective view of the attachment end of a wrist strap adapted to make a detachable connection with the attachment member,

FIG. 3 shows a side view of the attachment end of FIG. 2,

FIG. 4 shows an exploded view of the attachment member according to an embodiment,

FIG. 5 shows a similar view to FIG. 4, when the latch is in operational position on the attachment member;

FIG. 6 shows a perspective view from below of the attachment member of FIG. 4,

FIG. 7 shows a perspective view of a part of the watch case from the back when connected to the attachment end of a wrist strap via the attachment member,

FIG. 8 shows a cross-sectional view of the attachment end of a wrist strap, of the attachment member and of a portion of the watch case when the attachment end of the wrist strap is locked to the attachment member, and

FIG. 9 shows a similar view to FIG. 8, with the bolt of the latch disengaged from the fixing window of the attachment end of the wrist strap to allow the wrist strap to be detached from the watch case.

### EXEMPLES DE MODE DE RÉALISATION DE L'INVENTION

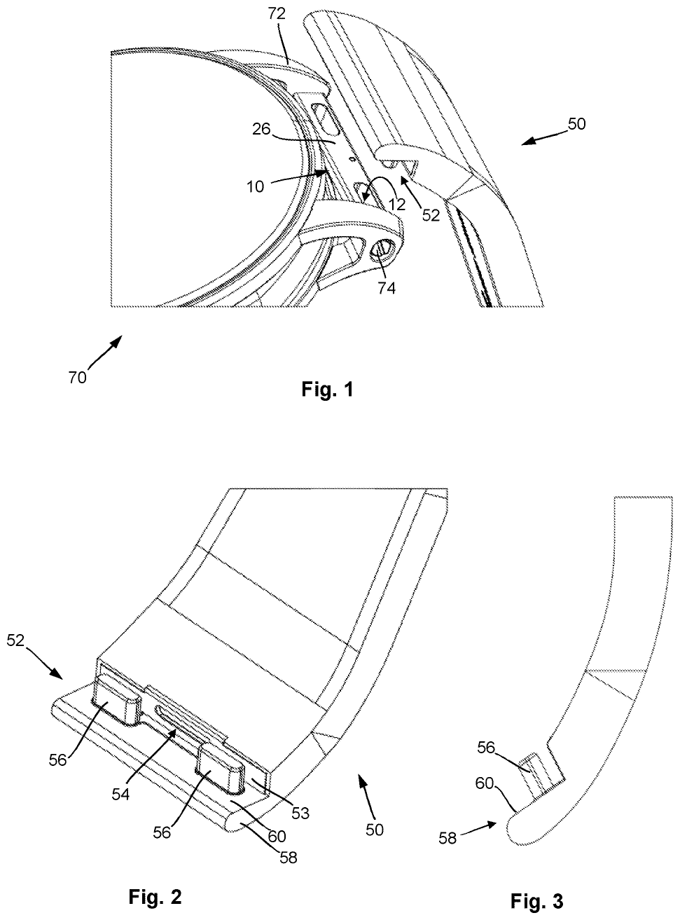

In a preferred embodiment and with reference in particular to FIGS. 1 to 3, the wristwatch comprises a watch case 70 typically comprising two pairs of horns 72 and an attachment member 10 intended to be mounted between the horns 72 of each pair, in particular fixed thereto by means of screws 74 for example. The wristwatch also comprises a bracelet, at least one wrist strap 50 of which comprises an attachment end 52 intended to be locked to the attachment member 10 in order to secure the wrist strap 50 to the watch case. The attachment member thus constitutes an interchangeable intermediate member, acting as an interface between the watch case and the attachment end 52 of the wrist strap.

The attachment member 10 comprises for this purpose a coupling element 12 located on a visible face of the attachment member when the assembly of the coupling element 12 with the attachment end 52 is not carried out. The coupling element 12 is configured to cooperate with the attachment end 52 so as to be able to assemble them by interlocking in a single particular direction, unlike the aforementioned prior art which requires the attachment end to be manipulated by two successive movements in two perpendicular directions with respect to each other. This particular direction is perpendicular or oblique to a plane defined by the two pairs of horns 72, for example a plane passing through the same parts of the horns, such as their ends. Such a plane corresponds to the general plane of the watch case. The attachment member 10 further comprises a latch 30 for locking and unlocking the assembly of the coupling element 12 to the attachment end 52.

With this assembly, which is obtained by fitting in a direction outside the extension of the wrist strap, in particular when the latter is essentially parallel to the general plane defined by the watch case, the locking mechanism is advantageously relieved when traction forces are exerted on the wrist strap. Consequently, the size of the latch or locking mechanism can advantageously be reduced because it is no longer required to withstand traction forces.

In a preferred embodiment, the coupling element of the attachment member is formed by at least one female element 12 configured to receive at least one male element 56 which is complementary in shape to the female element and which forms part of the attachment end 52. Preferably, the coupling element 12 is formed by at least two elements arranged on either side of the latch 30. These elements are chosen from female elements 12 and/or male elements 56. According to the preferred embodiment, the coupling element comprises two female elements 12 in the form of two holes, for example of oblong shape, extending right through the attachment member 10. Alternatively, these two holes 12 could also be two blind holes.

According to FIG. 2, the attachment end 52 of the wrist strap 50 is concealed under a portion 58 of the wrist strap at one of its ends intended to cover the attachment member 10 to render it invisible when the wristwatch is worn. The end of this portion 58 is in contact with or close to the watch case 70 when the wrist strap 50 is locked to the watch case 70, as illustrated in FIG. 8.

In a preferred embodiment, the attachment end 52 also comprises at least one male element, preferably two male elements 56, for example of oblong shape, arranged to be introduced into the two holes 12 in the attachment member. As already mentioned, the male elements 56 and female elements 12 are intended to be able to mate and, to this end, are preferably of complementary shapes. In addition, the male elements 56 are arranged on a first bearing surface 60 intended to bear against an upper surface 26 of the attachment member 10 (FIG. 6) when the attachment end 52 is locked to the attachment member 10.

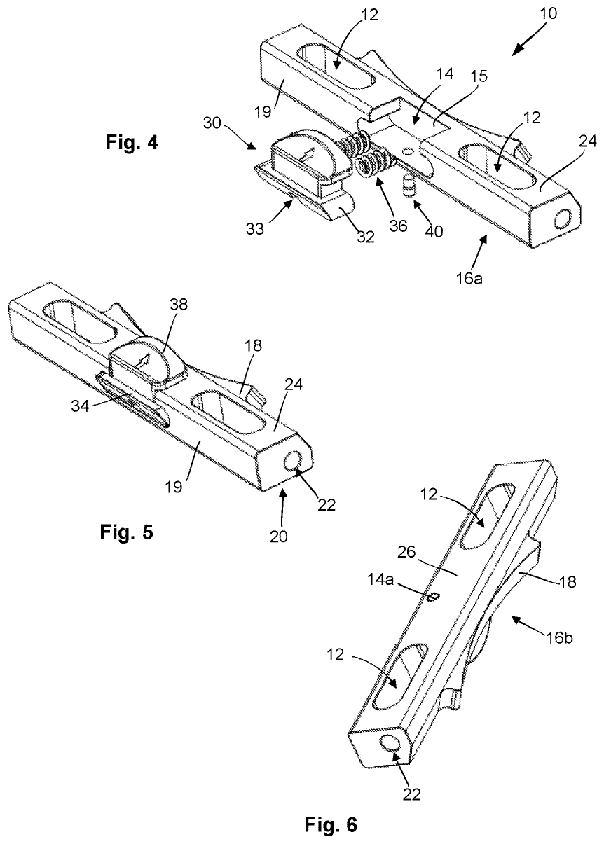

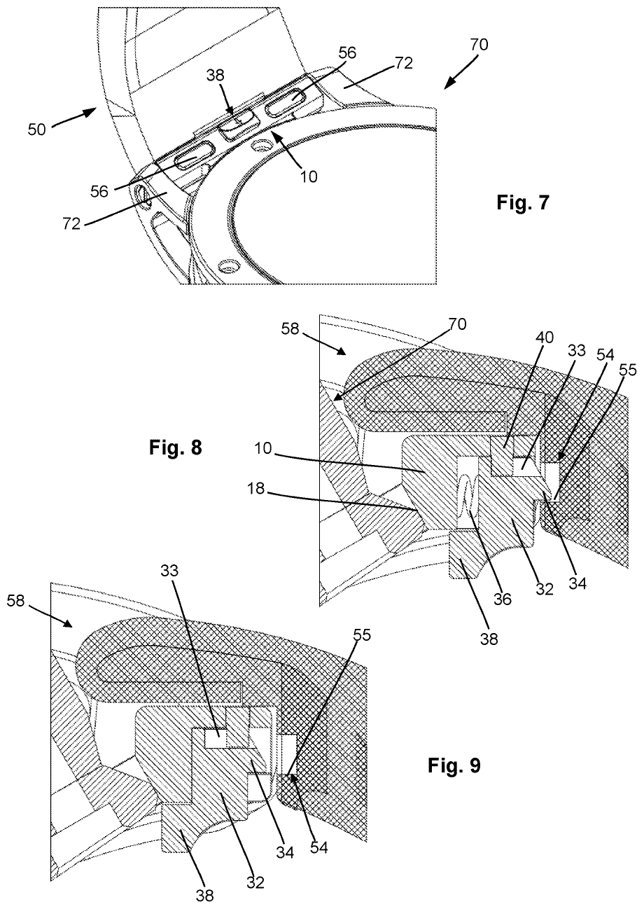

The attachment end 52 further comprises a second bearing surface 53 which, preferably, is adjacent to the first bearing surface 60 and substantially perpendicular thereto. The second bearing surface 53 is intended to bear against a third bearing surface 19 located on a first longitudinal side 16a of the attachment member 10 illustrated in FIGS. 4 to 5. In order to lock the assembly of the coupling element 12 and the attachment end 52, the latter comprises a rim, a fixing cavity or a window 54 intended to cooperate with the latch 30 integrated into the attachment member 10. The window 54 is typically arranged on this second bearing surface 53. In the preferred embodiment, the fixing window 54 is set back from the two male elements 56 and is preferably centered between them. More generally, it should be noted that the rim or the fixing window 54 is located between at least two elements complementary to the male 56 and/or female 12 elements forming the coupling element.

Advantageously, the first and second bearing surfaces of the attachment end 52 make it possible to obtain a better hold and/or rigidity of the assembly formed by the wrist strap and the attachment member.

With reference to FIGS. 4 to 5, the attachment member 10 comprises a recess 14 located on a lower surface 24 opposite the upper surface 26. The recess 14 is preferably centered between the two holes 12 and is configured to receive the latch 30 therein. This latch comprises a latch body 32 mounted movably, in particular slidably, in the recess 14 and a bolt 34 arranged to be positioned in the fixing window 54 of the attachment end 52 of the wrist strap when the latch 30 is in a locked configuration. Instead of the bolt 34, a hook could also be used to prevent any separation between the attachment end 52 and the coupling element 12 when the latch is in the locked position. In this case, the rim or fixing window could be configured to allow the hook to grip it.

The latch 30 further comprises an elastic member 36 intended to urge the latch into its locked position. This elastic member is preferably in the form of two compression springs 36. One end of each spring 36 rests against a side 15 of the recess 14, while the other end of each spring rests against the latch body 32 in order to urge the bolt 34 into the fixing window 54. A single spring of larger dimensions can be used in an alternative embodiment.

In non-illustrated alternative embodiments, the latch is mounted so as to pivot about an axis parallel to the lower surface 24 and the upper surface 26 of the attachment member 10, or even about an axis perpendicular to these surfaces. In these two cases, the bolt or hook is arranged on the latch body in order to engage the fixing window or fixing rim, by tilting or rotating the latch.

In another non-illustrated embodiment, the attachment part 12 comprises only one male element. The fixing window or fixing rim is located on this male element facing the bolt or the hook of the latch for locking the attachment end 52 of the wrist strap to the attachment member.

With reference to FIGS. 5 and 8, the latch 30 also comprises a trigger or gripping part 38 enabling the latch 30 to be moved in at least one direction between the locked and unlocked positions. Although the elastic member 36 automatically returns the latch from its unlocked position to its locked position, a configuration could be provided in which the latch could be blocked in at least one of these positions. Thus, to be able to move from one position to the other, the user would first have to unlock the latch, by initiating a movement applied to its gripping part 38. In the case where it is necessary to move from the unlocked position to the locked position, the elastic member 36 would be responsible for automatically terminating the movement of the latch. In the case of an opposite movement, it would be the user himself who would complete the movement of the latch against the return force exerted by the elastic member 36.

Preferably, the gripping part 38 is arranged so as to be accessible from an invisible face of the attachment member 10 when the latter is fastened between the pair of horns 72 and the wristwatch is worn, or is viewed from the dial side.

Preferably, the movement of the latch 30 is limited by a stop 40 preventing the latch from moving out of its recess 14. To do this, the latch body 32 may comprise, at its base, a blind groove 33 whose axis coincides with the axis of movement of the latch. This groove 33 is designed to receive a pin 40 housed through a hole 14a (FIG. 6) provided at the base of the recess 14. When the latch moves under the action of the elastic member 36, this pin limits its movement by abutting against the blind end of the groove 33.

In order to be able to fix the attachment member 10 between a pair of horns 72 of the watch case, this attachment member typically has two holes 22 located on its two lateral sides 20. The screws 74 are screwed into the horns 72 through tapped holes. The holes 22 accommodate the ends of the screws in order to fix the attachment member to the horns 72 of the watch case 70. In an alternative embodiment, each lug has only one non-tapped through hole, while the two holes 22 in the attachment member 10 are tapped to screw in the screws 74. These therefore constitute fixing points of the attachment member 10 to the horns 72 of the watch case.

Advantageously, and as clearly illustrated in FIGS. 4 to 6, the attachment member 10 further comprises on a second longitudinal side 16b, opposite the first longitudinal side 16a, a bearing surface 18 intended to come into contact with the watch case. Apart from its aesthetic function, this bearing surface is configured to substantially prevent any rotation of the attachment member when it is fixed between the horns 72. To this end, the bearing surface 18 preferably has a shape complementary to a portion of the watch case with which it may be in contact. In the aforementioned figures, this shape is curved to match a complementary curved portion of the watch case. It should be noted that the profile of this bearing surface 18 and of the assembly of the coupling element 12 and the attachment end 52 by interlocking advantageously makes it possible to fully prevent rotation of the bracelet around the horns. As a result, the lateral sides of the attachment end 52 at all times follow the profile of the horns of the watch case, thus guaranteeing remarkable aesthetics.

According to FIGS. 8 and 9, the bolt 34 is arranged above a lower rim 55 of the fixing window 54 when the latch 30 is in the locked configuration in order to prevent or limit a relative movement between the attachment end 52 of a wrist strap 50 and the attachment member 10 in a direction preferably substantially orthogonal to the plane of the watch case. It should be noted that in this position, the pin 40 is in abutment against an edge of the groove 33 of the latch body 30.

When a force is exerted on the gripping part 38 of the latch, in the direction of the watch case, the latch body 32 is brought against the side 15 of the recess. This movement enables the bolt 34 to be disengaged from the lower rim 55 of the fixing window 54 and allows relative movement between the attachment end 52 and the attachment member 10. This relative movement, which in this case takes place in a direction orthogonal to the plane of the watch case, allows the wrist strap to be disconnected from the attachment member.

From FIGS. 8 and 9, it becomes clear that the fixing window 54 could be replaced by a simple rim in order to prevent relative movement between the attachment end and the attachment member when the bolt 34 of the latch is engaged at the level of this rim.

The attachment member which has just been described allows neither the case nor the bracelet to be made more complex. Indeed, the most complex elements are advantageously constituted and contained in the attachment member 10. In the event of damage or defect, only this attachment member could be replaced without having to replace the watch case, for example. Also, given that the complexity of the attachment is not on the bracelet either, in particular at the attachment end of each wrist strap, the latter can be replaced at lower cost and more frequently, in particular when it is a leather wrist strap for example. Having a more economical bracelet also makes it easier to offer a collection of bracelets that are easily interchangeable and whose colors could be matched to the wearer's clothing, for example.

Various modifications can be made to the wristwatch just described without departing from the invention as defined by the claims. For example, the attachment member may comprise one or more male elements instead of holes, while the attachment end may comprise one or more female elements of complementary shape.

List of reference signs

Attachment member 10
Coupling element 12
Recess 14
Hole 14a
Side 15
First longitudinal side 16a
Bearing surface 19
Second longitudinal side 16b
Mating part 18 (e.g. curved portion)
Lateral sides 20
Hole 22
Lower surface 24
Upper surface 26
Latch 30
Latch body 32
Groove 33
Bolt 34
Elastic member 36 (e.g. compression spring)
Gripping part 38
Stop 40
Wrist strap 50
Attachment end 52
Bearing surface 53
Fixing window 54
Rim 55
Male elements 56
Portion 58
Bearing surface 60
Watch case 70
Horns 72
Screws 74

1. Attachment member intended for being secured between a pair of horns of a watch case, comprising two pairs of horns, for connecting the watch case to an attachment end of a wrist strap, the attachment member comprising a coupling element configured to engage with the attachment end in order to assemble the coupling element and the attachment end by interlocking in a direction perpendicular or oblique to a plane defined by the two pairs of horns of the watch case, the attachment member further comprising a latch movably mounted in a recess of the attachment member between a locked position and an unlocked position enabling the assembly of the coupling element to the attachment end to be locked and unlocked, wherein the coupling element is configured to be located on a visible side of the attachment member when the assembly between the coupling element and the attachment end is not carried out, and in that said assembly is carried out directly in a single movement by interlocking the coupling element and the attachment end.

2. Attachment member of claim 1, wherein the said visible side is visible on the bezel side of the watch case when the attachment member is fixed between the pair of horns thereof and the attachment end is not connected to the attachment member.

3. Attachment member of claim 1, wherein the latch comprises a hook or bolt configured to prevent separation between the attachment end and the coupling element when the latch is in the locked position.

4. Attachment member claim 1, wherein the movement of the latch is limited by a stop preventing the latch from moving out of the recess.

5. Attachment member of claim 1, characterised in that the locked position of the latch is reached and maintained by the action of an elastic member on the latch.

6. Attachment member of claim 1, wherein the latch comprises a gripping part enabling it to be moved in at least one direction between the locked and unlocked positions.

7. Attachment member of claim 6, wherein the gripping part is arranged to be accessible from an invisible side of the attachment member when the latter is fixed between the pair of horns and when the watch case is viewed from the bezel side.

8. Attachment member (10) of any preceding claim, characterised in that the coupling element (12) is formed by at least one female element (12) configured to receive at least one male element (56) of complementary shape of the attachment end (52).

9. Attachment member of claim 1, wherein the coupling element is formed by at least two elements, from among female and/or male elements, arranged on either side of the recess of the latch.

10. Attachment member of claim 1, further comprising a bearing surface intended to come into contact with the watch case, the bearing surface being configured to substantially prevent any rotation of the attachment member when it is fixed between the horns of the watch case.

11. Wrist strap comprising an attachment end configured to be connected, by interlocking, to the attachment member of claim 1.

12. Wrist strap of claim 11, wherein the attachment end comprises at least one male element configured to be fitted into the coupling element of the attachment member.

13. Wrist strap of claim 11, wherein the attachment end comprises a rim or a fixing window configured to cooperate with the latch of the attachment member in order to lock the assembly of the attachment end and the coupling element.

14. Wrist strap of claim 13, wherein the rim or the fixing window is located between at least two elements complementary to the male and/or female elements which form the coupling element of the attachment member.

15. Wrist strap of any of claim 11, wherein the attachment end is concealed beneath a portion of the strap overlying the attachment member when the attachment end is assembled to the attachment member.

16. Wristwatch comprising a watch case comprising two pairs of horns, an attachment member of any of claim 1 mounted between the horns of each pair of horns and a bracelet comprising the wrist strap of claim 11 fixed to each attachment member.
